(19) United States
(12) Patent Application Publication
(10) Pub. No.: US 2002/0164015 A1
(43) Pub. Date: Nov. 7, 2002

(54) Interface between phone line and microcomputer

(76) Inventors: Mauro Andre Dos Passos, Curitiba (BR); Alizes Helena Busato, Curitiba (BR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/118,333

(22) Filed: Apr. 9, 2002

(30) Foreign Application Priority Data
Apr. 11, 2001 (BR) PI 0101741-1

(51) Int. Cl. H04M 1/00; H04M 9/00

(52) U.S. Cl. 379/413.02

(57) ABSTRACT

The present patent being described as an interface between a phone line and a microcomputer which, pursuant to the characteristics thereof, has the function of communicating a phone line and the sound board of microcomputer in order to improve the communication, on the basis of construction of a sturdy and versatile interface. With a specific, easily accessible design and shape, practical handling and functionality characteristics, adaptable between any phone line and microcomputer. The present interface is comprised of a printed circuit board packaged in a box with an outlet for stereo audio cable for interconnection with the sound board of microcomputer and phone cable inlet for interconnection with phone line, employed jointly with a computer software installed in the microcomputer, which manages and defines the actual utilization of interface.

### BACKGROUND OF THE INVENTION

The present patent refers to electronic equipment in general, more specifically an interface between a phone line and a microcomputer which, pursuant to the characteristics thereof, possesses the functions of communication between a phone line and a microcomputer's sound printed circuit board, being intended to improve the communication therebetween, on the basis of the provision of an interface having a great strength, safety and versatility. With a specific design and shape, easily accessible for better adaptation and safety of the users, practical handling and operational characteristics, being compact, of very accessible cost and, by reasons of the general characteristics and dimensions thereof, is easily adaptable between any kind of phone line and a microcomputer.

### SUMMARY OF THE INVENTION

The patent in question is characterized in that it aggregates components and process in a differentiated concept. A concept that provides a highly functional, economic, efficient and versatile equipment without prejudice of the technical characteristics thereof, which provides advantages and improvements to the equipment, the general characteristics of which differ from the other forms and models known in the current state of the art.

The interface is quite versatile, by reason of the operation and assembly system, in addition to being low-cost and allowing a large amplitude of utilities requiring a reliable and direct communication between a phone line and the microcomputer sound board, independently of the trademark and model thereof, being easily employed by the users, with great safety and comfort, comprising an efficient external positioning interface, that is, it is located outside the microcomputer and the phone line and, according to the desired characteristics, it performs, allows or is amenable to the function of providing communication between the phone line and the microcomputer.

The present patent comprises the utilization of a modern, versatile, efficient and functional interface between a phone line and a microcomputer, comprised of a printed circuit board packaged in a small, rectangular shielded and sealed box made of high impact-strength plastic material of a similar, lighter and stronger material with an outlet to a stereo audio cable for interconnection to the microcomputer sound board and a phone cable inlet for interconnection to the phone utility line, employed jointly with a specific computer software installed and operated in a physical unit of the microcomputer, that manages and defines the actual utilization of the interface.

The present invention is based on the utilization of an interface to be employed for recording of phone calls in the microcomputer, in a manner different from the other forms and models known in the current state of the art and applicable to computer companies who need to record phone calls for technical support from their clients, to commercial departments who need to confirm orders, “telemarketing”/“call center” centrals who need to record suggestions/complaints from their clients, autonomous professionals who need to record their contact with clients. Any end user who needs to safely record its talks in general.

### BRIEF DESCRIPTION OF THE DRAWINGS

The objects, advantages and other important features of the patent in question can be more easily understood when read jointly with the drawings, the diagrams and the appended circuit, wherein:

FIG. 1 is a perspective view of the interface for phone line and microcomputer.

FIG. 2 is a schematic diagram of the connections of the interface for phone line and microcomputer.

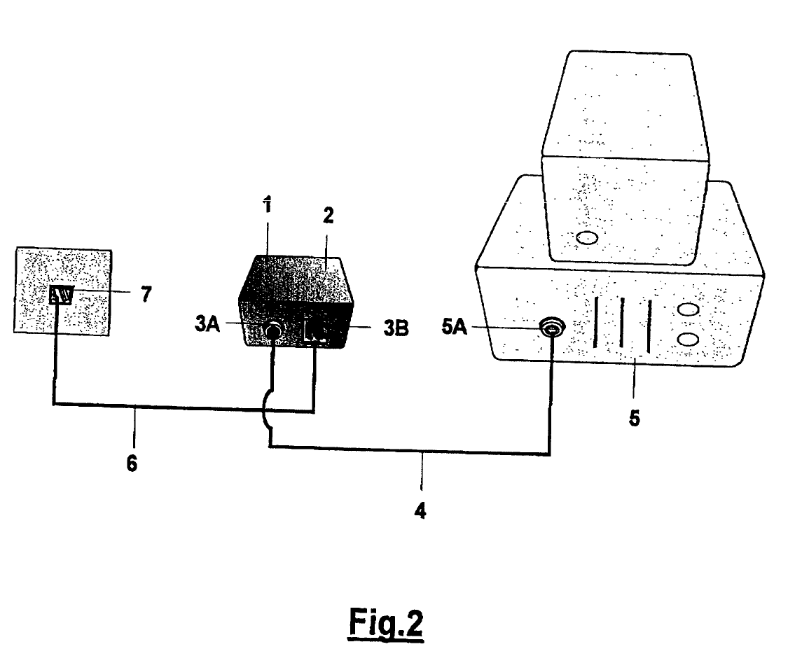

FIG. 3 is a view of the electric circuitry of the printed circuit board of the interface for phone line and microcomputer.

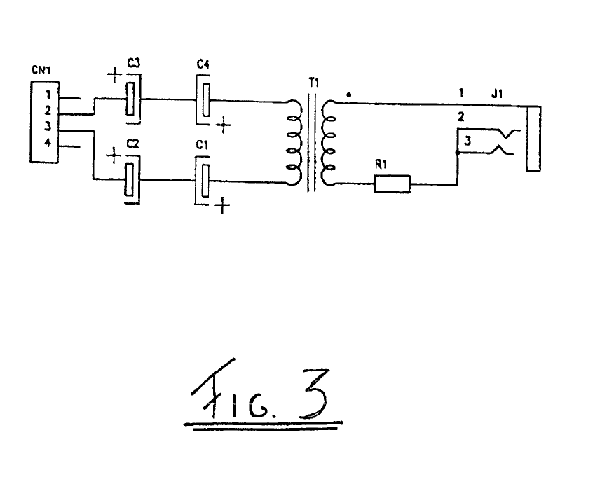

### DESCRIPTION OF THE PREFERRED EMBODIMENTS

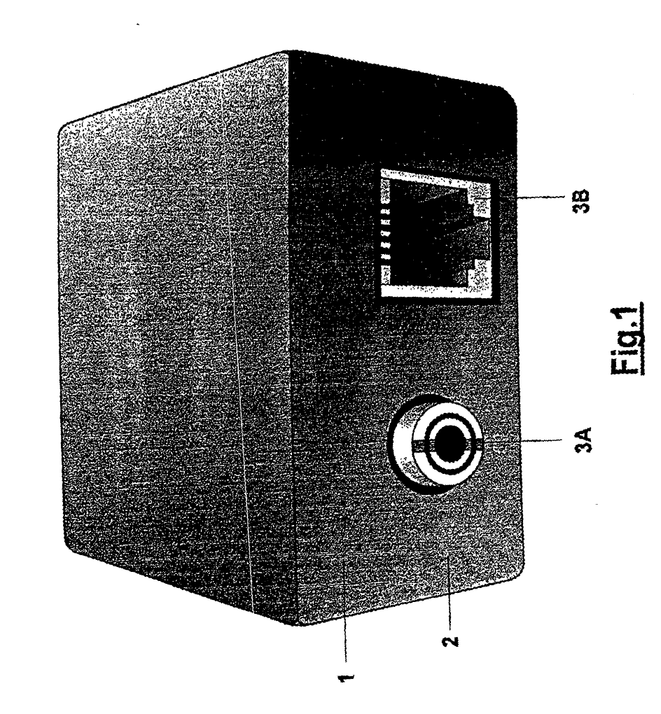

As can be inferred from the appended diagram and drawing, which illustrate and are an integral part of the present descriptive report for the patent of invention of “Interface between Phone Line and Microcomputer”, on FIG. 1 it is shown in a general manner, comprising an interface (1) fully integrated and packages inside a small box (2) of generally rectangular shape, made of high impact-strength plastic material or similar material of lighter weight and higher strength, with the parts thereof fully shielded and sealed, being immune to eventual violations, and comprised of a printed circuit board (3) containing four electrolytic capacitors (C1), (C2), (C3) and (C4), one resistor (R1), one transformer (T1), one female stereo plug (J1)(3A) for connection of a stereo audio cable (4) interconnecting the interface (1) to the microcomputer (5) through the sound board (5A) and a female RJ11 connector for the board (CN1)(3B) for connection of a phone cable (6) interconnecting the interface (1) to the phone line (7), simultaneously connecting the microcomputer (5) through a stereo audio cable (4) to a phone line (7) through a phone cable (6).

By means of the present interface (1) it is possible to employ more than one phone line (7) at the same time, that is, the interface (1) can make the simultaneous interconnection, communication, of several phone lines (7) to the sound board (5A) of the microcomputer (5)

The interface between the phone line and the microcomputer is quickly and easily assembled and/or disassembled between any phone line (7) and the microcomputer (5). After assembly and attachment, it remains fully locked, thereby preventing it from getting loose and/or be self-disassembled, there being nothing breakable therein during utilization thereof, since its components are protected by a small box (2) made of high impact strength plastic material or similar material. of lighter weight and higher strength, possessing a high durability, as shown on figure (1). Accordingly, the interface (1) can be employed without any concern in respect of safety.

The operation of interface (1) is based on the printed circuit board (3) packaged inside small box (2) and that performs the main communication functions between phone line (7) and sound board (5A) of microcomputer (5), through the specific cables, one being a phone cable and the other being a stereo audio cable (4), delivering information from the phone line (7) to the sound board (5A), with these information being processed and managed by a specific computer software installed and operated in a physical unit of the microcomputer (5), which defines the actual utilization of interface (1).

Where the interface is employed to record phone calls, the specific computer software for this program is operated, being the specific recording computer software. Whenever it is desired to record a phone call, the recording button in the software is positioned and the call will be recorded in the microcomputer's physical unit (5). Whenever it is desired to stop the recording, the stop button is pressed. The recordings can be sent via Internet. By means of the specific computer recording software it is possible to create several profiles, such as, for example: opening of calls, technical, private, commercial, client assistance and also to define recording directories, the maximum duration of a call, the insertion of details, among others.

The interface between phone line and microcomputer in question, by reason of the general characteristics and dimensions thereof, particularly where it is employed to record phone calls, provides a great ease of utilization and safety, allowing to record the phone calls in order to employ them as an information record and/or hearing them with more attention later on, generating more agility in the processing of information.

In view of the above, this is an invention that will be well received by the users or communication between a phone line (7) and a microcomputer (5), since the present interface presents countless advantages, such as: great safety, reliability and agility in communications; great durability, strength, flexibility and mobility; less and easier maintenance, more comfort for the user; lower wear of the assembly; a great yield and performance in the communications; very accessible costs; practical and save assembly between the phone line (7) and the microcomputer (5); and the certainty that an optimum communication will always be achieved.

Due to its general characteristics, the interface between the phone line and microcomputer is very useful and practical in any communication between these two media, since it allows a large range of uses, in a safe and reliable manner, thereby permitting an optimum performance and quick service by the receiver; however, the measurements, dimensions, quantities and values may vary, depending on the need of utilization.

We claim:

1. Interface between phone line and microcomputer, characterized in that it comprises an interface fully integrated into and packaged in a small box of generally rectangular shape, made of high impact strength plastic material or similar lighter and stronger material, with its parts being fully shielded and sealed, and comprised of a printed circuit board containing four electrolytic capacitors, one resistor, one transformer, one stereo female connector for connection to a stereo audio cable interconnecting the interface to the microcomputer through the sound board and a female RJ11 connector for the board for connection of a cable phone interconnecting the interface to the phone line, simultaneously connecting the microcomputer and the phone line through the interface.
